(19) United States
(12) Patent Application Publication
(10) Pub. No.: US 2020/0263484 A1
(43) Pub. Date: Aug. 20, 2020

(54) VACUUM INSULATED GLASS UNIT WITH A POLYMER SPACER MATRIX AND METHODS OF MAKING THE SAME

(71) Applicant: Corning Incorporated, Corning, NY (US)

(72) Inventors: Seo-Yeong Cho, Suwon-si (KR); Ki-yeon Lee, Suwon-si (KR); Kyung-jin Lee, Cheonan-si (KR); Yoon-seuk Oh, Asan-si (KR); Choon-bong Yang, Asan-si (KR)

(21) Appl. No.: 16/348,029

(22) PCT Filed: Nov. 2, 2017
(86) PCT No.: PCT/KR2017/012350

§ 371 Date: May 7, 2019

Related U.S. Application Data
(60) Provisional application No. 62/418,354, filed on Nov. 7, 2016.

(51) Int. Cl. E06B 3/66; E06B 3/663

(52) U.S. Cl. CPC E06B 3/6612; E06B 3/6775; E06B 3/66304

(57) ABSTRACT

A vacuum insulated glass unit (IGU) including an interconnected polymer spacer matrix and methods of making the same. The vacuum IGU includes a first glass-based layer, a second glass-based layer, an interconnected polymer spacer matrix, and an edge seal between the periphery of the first and second glass-based layers.

This application claims the benefit of priority under 35 U.S.C. § 119 of U.S. Provisional Application Ser. No. 62/418,354 filed on Nov. 7, 2016, the content of which is relied upon and incorporated herein by reference in its entirety.

### TECHNICAL FIELD

The present disclosure relates to a vacuum insulated glass unit (IGU) including a polymer spacer matrix.

### BACKGROUND ART

Conventional windows including vacuum IGUs use a plurality of discrete separated spacers to maintain the distance between opposing glass panes under vacuum pressure. Conventional spacers in vacuum IGUs are made from solder, glass, ceramic, metal, and other very hard materials and have small areas of contact with opposing glass panes in the IGU. This may lead to cracking of the glass panes and/or scratches on the glass pane surface(s) during thermal expansion thereof. Although softer materials may be desirable for spacers in vacuum IGUs, softer materials often cannot withstand the compressive stresses exerted thereon from opposing glass panes. Also, these softer materials sometimes require thermal activation which can reduce the strength of and/or diminish surface characteristics of the opposing glass panes.

Accordingly, a need exists for a polymeric spacer configuration for use in vacuum insulated glass units (IGUs).

### DISCLOSURE OF INVENTION

### Solution to Problem

According to one embodiment of the present disclosure, an article including a first glass-based layer, a second glass-based layer, an interconnected polymer spacer matrix, and a seal is disclosed. In embodiments the second glass-based layer is spaced apart from the first glass-based layer. In embodiments the interconnected polymer spacer matrix is between the first glass-based layer and second glass-based layer. In embodiments, the seal between the periphery of the first glass-based layer and the second glass-based layer creates a sealed space between the first and second glass-based layers.

According to another embodiment of the present disclosure, a window is disclosed. In embodiments, the window includes a first glass pane, a second glass pane, an interconnected polymer spacer matrix, and a seal. In embodiments, the second glass pane is spaced apart from the first glass pane. In embodiments, the interconnected polymer spacer matrix is directly or indirectly coextensive with the first glass pane and the second glass pane. In embodiments, the seal connects the periphery of the first glass pane and the second glass pane and creates a sealed space between the first and second glass panes.

According to yet another embodiment of the present disclosure, methods of making a vacuum insulated glass window is disclosed. In embodiments, the method includes applying an interconnected polymer spacer matrix to one or both of a first glass-based layer or a second glass-based layer. In embodiments, the method includes arranging the first glass-based layer relative to the second glass-based layer such that the interconnected polymer spacer matrix is directly or indirectly coextensive with the first glass-based layer and the first glass-based layer. In embodiments, the method includes sealing the periphery of the first glass-based layer to the second glass-based layer to form a sealed space therebetween.

Before turning to the following Detailed Description and Figures, which illustrate exemplary embodiments in detail, it should be understood that the present inventive technology is not limited to the details or methodology set forth in the Detailed Description or illustrated in the Figures. For example, as will be understood by those of ordinary skill in the art, features and attributes associated with embodiments shown in one of the Figures or described in the text relating to one of the embodiments may well be applied to other embodiments shown in another of the Figures or described elsewhere in the text.

### BRIEF DESCRIPTION OF DRAWINGS

The disclosure will be better understood, and features, aspects and advantages other than those set forth above will become apparent when consideration is given to the following detailed description thereof. Such detailed description makes reference to the following drawings, wherein:

FIG. 1 is a perspective view of an example vacuum insulated glass window according to exemplary embodiments.

FIG. 2 is a perspective view of an example vacuum insulated glass window according to exemplary embodiments.

FIG. 3 is a cross-sectional view of the vacuum insulated glass window in FIG. 1 along plane A-A.

### MODE FOR THE INVENTION

Unless defined otherwise, all technical and scientific terms used herein have the same meaning as commonly understood by one of ordinary skill in the art to which the disclosure belongs. Although any methods and materials similar to or equivalent to those described herein can be used in the practice or testing of the present disclosure, the exemplary methods and materials are described below.

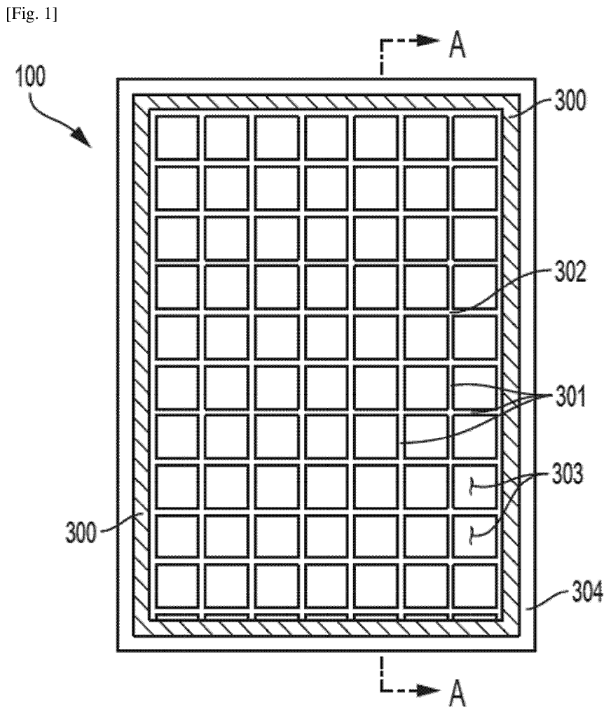

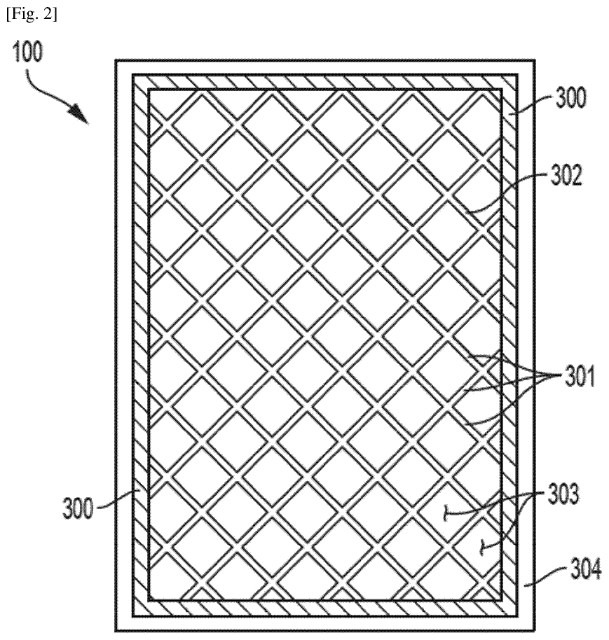

The present disclosure provides an article including a first glass-based layer 102, a second glass-based layer 202, a polymer spacer matrix 302, and a seal 300. In embodiments the article is a vacuum insulated glass unit (IGU), a glass-based package, an enclosure for an electronic device, a photovoltaic (PV) package, or a laminate. In embodiments, the vacuum IGU may be included in a vacuum insulated glass (VIG) window 100. FIGS. 1 and 2 illustrate example embodiments of a VIG window 100 including a vacuum IGU. Window 100 may include a frame 304 around the vacuum IGU. Frame 304 may be configured to communicate with an opening in a building, a structure, an enclosure, or a vehicle. VIG window 100 may be movable with respect to an opening in a building, a structure, an enclosure, or a vehicle.

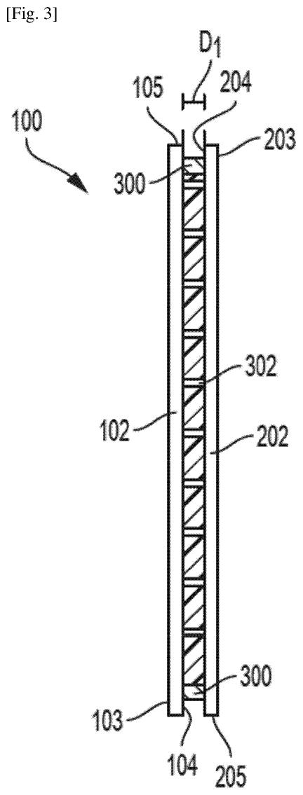

Referring to FIG. 3, a cross-section of VIG window 100 in FIG. 1, first glass-based layer 102 includes opposite surfaces 103, 104 and an outer edge 105. In embodiments, the second glass-based layer 202 includes opposite surfaces 203, 204 and an outer edge 205. In embodiments, second glass-based layer 202 is spaced apart from first glass-based layer 102 by a first distance Dl. Distance D1 may be from about 10 microns to about 250 microns, or from about 20 microns to about 150 microns, or even from about 20 microns to about 100 microns. In embodiments, first glass-based layer 102 is disposed substantially parallel to second glass-based layer 202. In embodiments, first glass-based layer 102 and second glass-based layer 202 may have a thickness between their opposite surfaces from about 0.5 mm to about 6 mm, or from about 0.7 mm to about 3 mm, or even from about 1 mm to about 2.5 mm, such as 0.5, 1, 1.5, 2, 1.5, 3, 3.5, 4, 4.5, 5, 5.5, 6 mm or more, and all ranges and subranges therebetween. In embodiments, surface 104 of first glass-based layer 102 faces surface 204 of second glass-based layer 202. In embodiments, first glass-based layer 102, second glass-based layer 202, or both may include a low emissivity coating. Commercially available low emissivity coatings are available from Guardian Industries, Inc. or Cardinal IG Company, for example. Any combination of the opposite surfaces of first and second glass-based layers 102, 202 may be etched (e.g., wet chemical etching, plasma etching, etc.) to create a cavity therein. First and second glass-based layers 102, 202 may be glass panes.

Polymer spacer matrix 302 is between first and second glass-based layers 102, 202. In embodiments, polymer spacer matrix 302 is directly or indirectly coextensive with the first glass-based layer 102 and second glass-based layer 202. Polymer spacer matrix 302 is an interconnected matrix of a polymer-based material. Interconnected polymer spacer matrix 302 is not a plurality of discrete spaced apart spacers used in conventional vacuum IGUs. In embodiments, interconnected polymer spacer matrix 302 has a surface area from about 20% to about 90%, or from about 30% to about 80%, of either opposite surface of first or second glass-based layers 102, 202. The surface area of interconnected polymer spacer matrix 302 reduces the compressive stress on individual points present in conventional vacuum IGUs including conventional discrete spaced apart spacers. In embodiments, interconnected polymer spacer matrix 302 is a network of polymer-based segments 301 that intersect and form a plurality of open plenums 303 therebetween. In embodiments, the network of polymer-based segments 301 may have a grid or lattice pattern that form the plurality of open plenums 303, as shown in FIGS. 1 & 2. Or course other patterns for the network of polymer-based segments 301 is in accordance with the present disclosure. Polymer spacer matrix 302 is configured to maintain distance D1 between first glass-based layer 102 and second glass-based layer 202. In embodiments, polymer spacer matrix 302 is configured to resist a compressive force (e.g., vacuum pressure) between first glass-based layer 102 and second glass-based layer 202. Polymer spacer matrix 302 may be substantially transparent or clear before and/or after a curing operation. That is, polymer spacer matrix 302 may transmit greater than about 60% of visible wavelengths. In embodiments, the appearance of objects and colors through polymer spacer matrix 302 are not substantially distorted.

Each open plenum 303 is defined, at least in part, by first glass-based layer 102, second glass-based layer 202, and polymer spacer matrix 302. Each open plenum 303 may have a shape including a square, a triangle, a quadrilateral, or similar. In embodiments, the plurality of open plenums 303 are separate and discrete. In embodiments, at least one of the plurality open plenums 303 may have a combination of these shapes. In embodiments, at least one of the plurality of open plenums 303 includes a pressure less than atmospheric pressure. In embodiments, at least one of the plurality of open plenums 303 includes a vacuum pressure (e.g., 10⁻² torr or less). In embodiments, polymer spacer matrix 302 includes a thickness from about 10 microns to about 200 microns, or from about 20 microns to about 100 microns, such as 20, 30, 40, 50, 60, 70 80, 90, 100 microns, including all ranges and subranges therebetween. In embodiments, polymer spacer matrix 302 spans substantially across distance D1 between first glass-based layer 102 and second glass-based layer 202. In embodiments, the thickness of polymer spacer matric 302 is substantially the same as (e.g., ±5%) distance D1 between first glass-based layer 102 and second glass-based layer 202.

In embodiments, polymer spacer matrix 302 includes a polymer-based material including ethylene vinyl acetate, polyether sulfone, polyamide, polyethylene terephthalate, polyurethane, polyolefin, or combinations thereof. In embodiments, polymer spacer matrix 302 includes nylon, thermoplastic polyurethane, or a combination thereof. In embodiments, polymer spacer matrix 302 includes a polymer-based material with a melting or curing temperature less than about 200° C. In embodiments, the polymer-based material of polymer spacer matrix 302 may degrade or disintegrate at temperatures above about 200° C. Polymer spacer matrix 302 may include a polymer-based material with a melting or curing temperature from about 50° C. to about 175° C., or from about 100° C. to about 150° C., or even from about 100° C. to about 120° C., such as 50° C., 75° C., 100° C., 125° C., 150° C., 175° C. or up to 200° C., including all ranges and subranges therebetween. This lower melting or curing temperature of the polymer-based material in polymer spacer matrix 302 may reduce thermal defects, sagging, or loss of strengthening in first and second glass-based layers 102, 202. In embodiments, polymer spacer matrix 302 includes a film including one of said polymer-based materials. The film may assist polymer spacer matrix 302 to retain its structure or shape between first and second glass-based layers 102, 202 or while polymer spacer matrix 302 is applied to one or both of first and second glass-based layers 102, 202.

Seal 300 is between first glass-based layer 102 and second glass-based layer 202. In embodiments, seal 300 is provided along the edge or periphery of first glass-based layer 102 and second glass-based layer 202. In embodiments, seal 300 connects the edge or periphery of first glass-based layer 102 and second glass-based layer 202. Seal 300 creates a sealed space between first glass-based layer 102 and second glass-based layer 202. In embodiments, seal 300 directly or indirectly bonds first glass-based layer 102 and second glass-based layer 202. Seal 300 may be formed by applying heat or laser energy to glass frit, solder, energy absorbing films, or similar materials. FIG. 3. Illustrates seal 300 as an indirect bond with a shim filling distance D1 between first glass-based layer 102 and second glass-based layer 202. The sealed space includes polymer spacer matrix 302. The sealed space is defined, at least in part, by first glass-based layer 102, second glass-based layer 202 and seal 300. Sealed space 300 may be a hermetic seal. Sealed space 300 may include a gas (e.g., air, argon, nitrogen, helium, etc.). Sealed space 300 may include a pressure less than atmospheric pressure. In embodiments, sealed space 300 includes a vacuum pressure (e.g., 10⁻² torr or less).

In embodiments, first glass-based layer 102 and/or second glass-based layer 202 may include soda lime glass, aluminosilicate glass, alkali-aluminosilicate glass, borosilicate glass, alkali-borosilicate glass, aluminoborosilicate glass, alkali-aluminoborosilicate glass, soda lime silicate glass, and other suitable glasses. Again, first glass-based layer 102 and/or second glass-based layer 202 may be a glass pane. Glass panes may be for architectural applications and consistent with ASTM standards, ANSI standards, British and European Standards (BF EN) for glass in buildings, and/or Consumer Product Safety Commission (CPSC) standards. Glass herein may be formed by slot-draw or float processes.

In embodiments, first glass-based layer 102, second glass-based layer 202, or both are strengthened. Strengthening of first and/or second glass-based layers 102, 202 may provide for lighter and stronger articles (e.g., vacuum IGUs) disclosed herein. Strengthened first glass-based layer 102 and/or second glass-based layer 202 includes thermally strengthened, chemically strengthened, mechanically strengthened, thermally and chemically strengthened, thermally and mechanically strengthened, or chemically and mechanically strengthened. In embodiments, first glass-based layer 102 includes a thermally strengthened glass layer, a chemically strengthened glass layer, a mechanically strengthened glass layer, a thermally and chemically strengthened glass layer, a thermally and mechanically strengthened glass layer, or a chemically and mechanically strengthened glass layer. In embodiments, second glass-based layer 202 includes a thermally strengthened glass layer, a chemically strengthened glass layer, a mechanically strengthened glass layer, a thermally and chemically strengthened glass layer, a thermally and mechanically strengthened glass layer, or a chemically and mechanically strengthened glass layer.

Methods of forming articles disclosed herein may include applying the interconnected polymer spacer matrix 302 to at least one of first glass-based layer 102 and second glass-based layer 202. In embodiments, polymer spacer matrix 302 is applied to first or second glass-based layer 102, 202 by spraying, direct application, silk screening, or other similar processes. Methods of forming articles disclosed herein may include arranging first glass-based layer 102 relative to second glass-based layer 202. In embodiments, first glass-based layer 102 is arranged relative to second glass-based layer 202 such that polymer spacer matrix 302 is directly or indirectly coextensive with first glass-based layer 102 and second glass-based layer 202. In embodiments, first glass-based layer 102 is arranged relative to second glass-based layer 202 such that edges 105, 205 overlap at least at one point.

Methods of forming articles disclosed herein may include sealing the periphery of first glass-based layer 102 and second glass-based layer 202 to form the sealed space therebetween. Sealing between first glass-based layer 102 and second glass-based layer 202 may include welding, sintering, heating, joining, laser bonding, and other similar processes. Sealing between first glass-based layer 102 and second glass-based layer 202 may include providing a shim between first glass-based layer 102 and second glass-based layer 202 to fill distance D1.

Methods of forming articles disclosed herein may include forming a pressure less than atmospheric pressure within the sealed space. Forming the sub-atmospheric pressure within the sealed space may be accomplished by pumping, sucking, of removing a fluid from the sealed space through an aperture in first glass-based layer 102, second glass-based layer 202, or along seal 300. Following formation of the sub-atmospheric pressure within the sealed space, the aperture may be sealed to hermetically seal said sub-atmospheric pressure within the sealed space.

Methods of forming articles disclosed herein may include heating polymer spacer matrix 302 at a temperature below about 200° C. to at least partially cure the polymer-based material therein. Heating polymer spacer matrix 302 may also fuse polymer spacer matrix 302 directly or indirectly to first glass-based layer 102 and/or second glass-based layer 202. Heating polymer spacer matrix 302 may include heating first glass-based layer 102 and second glass-based layer 202 simultaneously. Heating polymer spacer matrix 302, first glass-based layer 102, and second glass-based layer 202 below about 200° C. may prevent thermal defects, sagging, or loss of strengthening of in first and second glass-based layers 102, 202. Heating polymer spacer matrix 302, first glass-based layer 102, and second glass-based layer 202 may also simultaneously seal the periphery of first glass-based layer 102 and second glass-based layer 202 and form the sealed space therebetween. In embodiments, heating may be done under vacuum to simultaneously form a pressure less than atmospheric pressure within the sealed space.

Methods of making articles disclosed herein may include applying a first polymer-based film (e.g., ethylene vinyl acetate) to one or both of first and second glass-based layers 102, 202. Methods may include subsequently applying a second polymer-based film (e.g., polyethylene terephthalate) that is on one of both of first and second glass-based layers 102, 202 on top of the first polymer-based film. One or both of first and second polymer-based films is part of polymer spacer matrix 302. One or both of first and second polymer-based films may be patterned as an interconnected matrix. Methods may include subsequently arranging the first and second glass-based layers 102, 202 such that polymer spacer matrix 302 including at least one film is provided therebetween. Methods may include thermal vacuum sealing the article (including at least first and second glass-based layers 102, 202 and polymer spacer matrix 302) to create seal 300 and the sealed space between the first and second glass-based layers. Thermal vacuum sealing may be at a temperature below 200° C. (e.g., at a melting or curing temperature of a polymer-based material within polymer spacer matrix 302) and at vacuum pressure (e.g. 10−3 torr or less) to create a pressure less than atmospheric pressure within the sealed space or at least one of the plurality of open plenums 303. Thus, the disclosed methods may provide significant time savings and manufacturing advantages as compared to conventional vacuum IGU manufacturing processes.

As used herein, the singular forms “a,” “an,” and “the” include plural referents unless the context clearly dictates otherwise. Thus, for example, reference to a “polymer” includes examples having two or more such “polymers” unless the context clearly indicates otherwise.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It is also noted that recitations herein refer to a component of the present disclosure being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

It will be apparent to those skilled in the art that various modifications and variations can be made to the present disclosure without departing from the spirit and scope of the disclosure herein. Since modifications combinations, sub-combinations and variations of the disclosed embodiments incorporating the spirit and substance of the present disclosure may occur to persons skilled in the art, the present disclosure should be construed to include everything within the scope of the appended claims and their equivalents.

1. An article comprising:
a first glass-based layer;
a second glass-based layer spaced apart from the first glass-based layer;
an interconnected polymer spacer matrix between the first glass-based layer and second glass-based layer; and
a seal between the periphery of the first glass-based layer and the second glass-based layer that creates a sealed space between the first and second glass-based layers, the sealed space comprising the interconnected polymer spacer matrix.

2. The article of claim 1 wherein the first glass-based layer,
second glass-based layer, or both the first glass-based layer and the second glass-based layer are strengthened.

3. (canceled)

4. The article of claim 1, wherein the interconnected polymer spacer matrix comprises ethylene vinyl acetate, polyether sulfone, polyamide, polyethylene terephthalate, polyurethane, polyolefin, or combinations thereof.

5. The article of claim 1, wherein the interconnected polymer spacer matrix comprises a polymer-based material with a melting temperature less than about 200° C.

6. The article of claim 1, wherein the interconnected polymer spacer matrix comprises a thickness from about 20 microns to about 100 microns.

7. The article of claim 1, wherein the interconnected polymer spacer matrix comprises a film between the first glass-based layer and second glass-based layer.

8. The article of claim 1, wherein the interconnected polymer spacer matrix comprises a network of polymer-based segments that intersect and form a plurality of open plenums therebetween.

9. The article of claim 8 wherein at least one of the plurality of open plenums comprises a pressure less than atmospheric pressure.

10. The article of claim 1, wherein the interconnected polymer spacer matrix is directly or indirectly coextensive with the first glass-based layer and the second glass-based layer.

11. A insulation unit comprising:
a first glass pane;
a second glass pane spaced apart from the first glass pane;
an interconnected polymer spacer matrix between and directly or indirectly coextensive with the first glass pane and the second glass pane; and
a seal that connects the periphery of the first glass pane and the second glass pane and creates a sealed space between the first and second glass panes, wherein the sealed space comprises the interconnected polymer spacer matrix.

12. The insulation unit of claim 11 wherein the interconnected polymer spacer matrix comprises a network of polymer-based segments that intersect and form a plurality of open plenums therebetween.

13. The insulation unit of claim 11 wherein the sealed space further comprises a plurality of open plenums at least partially defined by the interconnected polymer spacer matrix and the first and second glass panes.

14. The insulation unit of claim 11, wherein at least one of the plurality of open plenums comprises a pressure less than atmospheric pressure.

15. (canceled)

16. The insulation unit of claim 11, wherein the interconnected polymer spacer matrix comprises ethylene vinyl acetate, polyether sulfone, polyamide, polyethylene terephthalate, polyurethane, polyolefin, or combinations thereof.

17. The insulation unit of claim 11, wherein the interconnected polymer spacer matrix comprises a polymer-based material with a melting temperature less than about 200° C.

18. The insulation unit of claim 11, the interconnected polymer spacer matrix comprises a thickness from about 20 microns to about 100 microns.

19. The insulation unit of claim 11, the second glass pane is spaced apart from the first glass pane by a distance from about 20 microns to about 150 microns.

20. The insulation unit of claim 11,
wherein the first glass pane, the second glass pane, or both comprises a low emissivity layer.

21. A vacuum insulated glass (VIG) window comprising the insulting unit of claim 11.

22. A method of making the article of claim 1 comprising:
applying the interconnected polymer spacer matrix to at least one of the first glass-based layer and the second glass-based layer,
arranging the first glass-based layer relative to the second glass-based layer such that the interconnected polymer spacer matrix is directly or indirectly coextensive with the first glass-based layer and the second glass-based layer; and
sealing the periphery of the first glass-based layer to the second glass-based layer to form a sealed space therebetween.

23. (canceled)

24. (canceled)
